(19) United States
(12) Patent Application Publication
(10) Pub. No.: US 2016/0132976 A1
(43) Pub. Date: May 12, 2016

(54) Bilateral Service App For Wine Tracking And Management

(71) Applicant: Hsien-Rong Liang, New Taipei City (TW)

(72) Inventor: Hsien-Rong Liang, New Taipei City (TW)

(21) Appl. No.: 14/540,014

(22) Filed: Nov. 12, 2014

(51) Int. Cl. G06Q 50/12; G06Q 30/02; H04W 4/00

(52) U.S. Cl. CPC G06Q 50/12; H04W 4/008; G06Q 30/0282

(57) ABSTRACT

A bilateral service app for wine tracking and management includes, structurally, a service function device, which enables a sales side to track and manage information related to a user side, a linking device, which allows the user side to the wine information storage device to inquire information related to the wine, a data recording module, which records drinking condition of the user side in respect of the wine, and a user feedback module, which allows the user side to provide comments regarding the wine. With the above structure, the user side, before purchasing a bottle of wine, may connect, via the linking device, to the wine information storage device to inquire information related to the wine and may record the drinking condition of the wine in the data recording module and provide comments of the wine in the user feedback module.

### (a) TECHNICAL FIELD OF THE INVENTION

The present invention generally relates to a bilateral service app for wine tracking and management, and more particularly to a bilateral service app for wine tracking and management that provides a user side with related information and after service of wine and also allows the user side to provide feed back and share experience of drinking the wine and comments to help the user side and a sales side to manage and collect wine.

### (b) DESCRIPTION OF THE PRIOR ART

Wine tasting is a science more than a skill and requires severe steps and rules. It is applicable to each person. And, there is also professional certificate for wine tasters. Wine tasting allows a drinking person to realize the background of the wine that he or she is drinking, such as production place and cellaring history. Wine tasting has been long a popular culture of the Western countries and it provides drinking with an intrinsic value.

General consumers are generally aware that the quality of wine is better if the wine has an old age and a famous brand. They often spend a great amount of money to purchase a bottle of the so-called “famous” wine and lack of the idea of how to drink and when is the best time for drinking and thus may just spoil a bottle of good wine.

The wine taste or drink culture discussed above may be just not good for general consumers for there are certain issues to be further improved:

(1) There is only very rough information provided on the wine bottle and there is no way to get aware of the value of the wine.

(2) There is no way to get aware of how to preserve and when to drink after the purchase of a bottle of wine and thus it is often that the best taste of the wine may be lost.

(3) Manufacturers or vendors cannot get aware of the consumers' comments after they purchase and drink a specific type of wine.

(4) Manufacturers or vendors provide timely recommendation or make timely tracking to suit the needs of the wine lovers and may thus lose their customers.

Thus, it is a challenge of the present inventor and those involved in the business to provide a solution to overcome the above problems.

### SUMMARY OF THE INVENTION

In view of the above problems and drawbacks, the present invention aims to provide a bilateral service app for wine tracking and management that helps the sales side to track the condition of drinking of the lovers of the wine provided thereby and to manage the quality of the wine owned thereby according to the needs and suggestions of the user side.

An object of the present invention is to allow a user side to connect, via a linking device, to a wine information storage device to inquire the information related to wine and also to record the drinking condition of the wine in a data recording module and also to provide their needs for drinking and suggestions of wine through a user feedback module, and also to allow a sales side to get aware of all sorts of information from the user side through a service function device in order to maintain constant tracking and management.

To achieve the above object, the present invention comprises, structurally, a service function device, a linking device mounted to the wine, a wine information storage device in information connection with the linking device, a data recording module arranged in the service function device, and a user feedback module arranged in the service function device. A user, when purchasing a bottle of wine, may connect, via the linking device mounted to the bottle of wine, to the wine information storage device to inquire information related to the wine and may record, via the service function device, the user's personal drinking condition in the data recording module and provide comments regarding the wine in the user feedback module. The sales side may use the service function device to get aware of the needs and suggestions of the user side in order to maintain constant tracking management of the drinking condition of the wine to thereby enhance the user's appetite of purchasing.

With the above techniques, the problems that in the known wine drinking culture, the user side is not provided with sufficient information regarding wine and lacks of professional instruction regarding the art of wine drinking and the sales side cannot get aware of the condition of the wine being drunk and has no way to suit the needs of the users or to prompt products can be overcome and the above-discussed practical advantage can be achieved.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a preferred embodiment of the present invention.

FIG. 2 is a block diagram of the preferred embodiment of the present invention.

FIG. 3 is a tree diagram illustrating service items of a bidirectional service device of the preferred embodiment of the present invention.

FIG. 4 is a tree diagram illustrating storage items of a wine information storage device of the preferred embodiment of the present invention.

FIG. 5 is a schematic view illustrating a bidirectional service of the preferred embodiment of the present invention.

FIG. 6 is a schematic view illustrating a flow of process of the preferred embodiment of the present invention.

FIG. 7 is a schematic view illustrating an example of use of the preferred embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

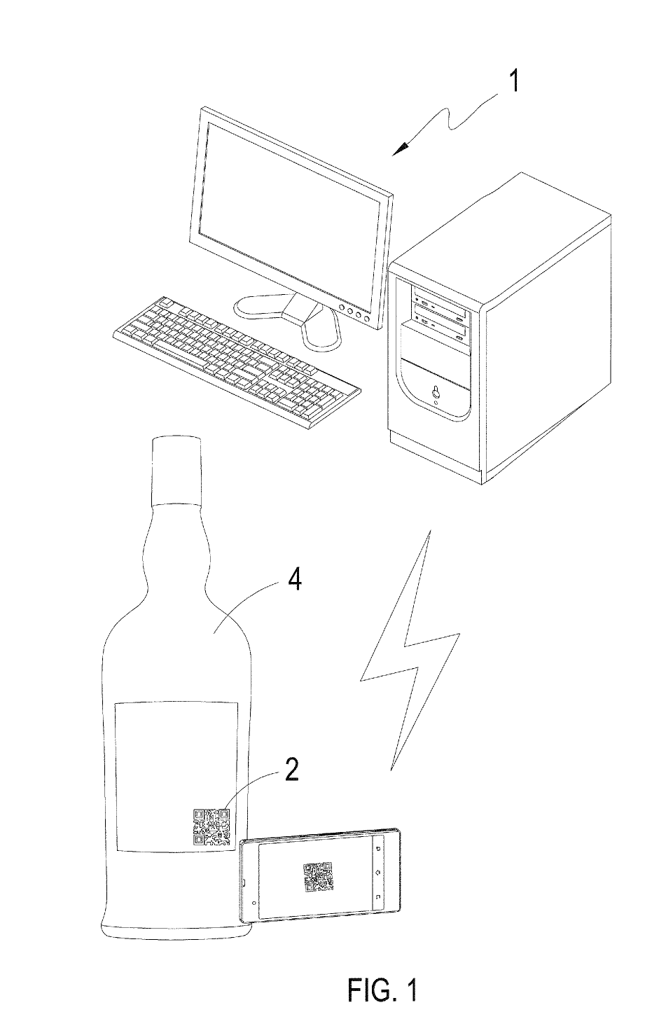

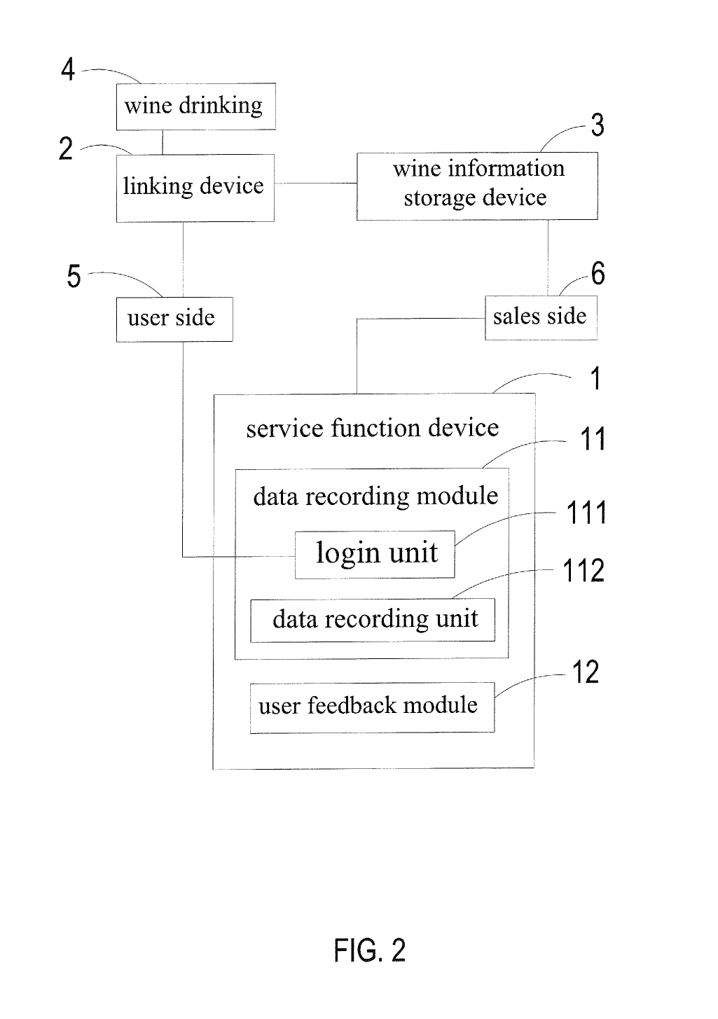

Referring to FIGS. 1 and 2, which are respectively a perspective view and a block diagram of a preferred embodiment of the present invention, the drawings clearly show that the present invention comprises:

a service function device 1, which enables a sales side 6 to track and manage information related to a user side 5;

a linking device 2, which is mounted to wine 4, the linking device 2 allowing the user side 5 to inquire information related to the wine 4, the linking device 2 being one of barcode, QR code, and near field communication (NFC), the wine 4 being one of red wine, white wine, and yellow rice or millet wine;

a wine information storage device 3, which is in information connection with the linking device 2, the wine information storage device modifying and updating information of the wine 4 through the service function device 1, the wine information storage device 3 containing storage items including name, year, source, information of producer and recommendation of drinking, purchasing date, market value, and stock list of the wine 4;

a data recording module 11, which is arranged in the service function device 1 to record the drinking condition of the wine 4 or the cellaring condition of the wine 4, wherein the data recording module 11 comprises website access, mobile applications (APP), or electronic documents and the data recording module 11 comprises at least one login unit 111 for information connection with the user side 5 and a data recording unit 112 for recording the drinking condition of the wine 4, personal information of the user side 5, and the cellaring condition of the wine 4, in which the drinking condition includes purchasing date, preservation time, preservation location, drinking time, drinking amount, and drinking purpose of the wine 4 and the cellaring condition includes cellar location, storage cabinet, quantity of stock, and cellaring environment of the wine; and

a user feedback module 12, which is arranged in the service function device 1 to allow the user side 5 to provide comments about the wine 4, wherein the comments of the wine 4 include remarks and ranking made by the user side 5 regarding the wine 4 and remarks and other suggestions to the producer.

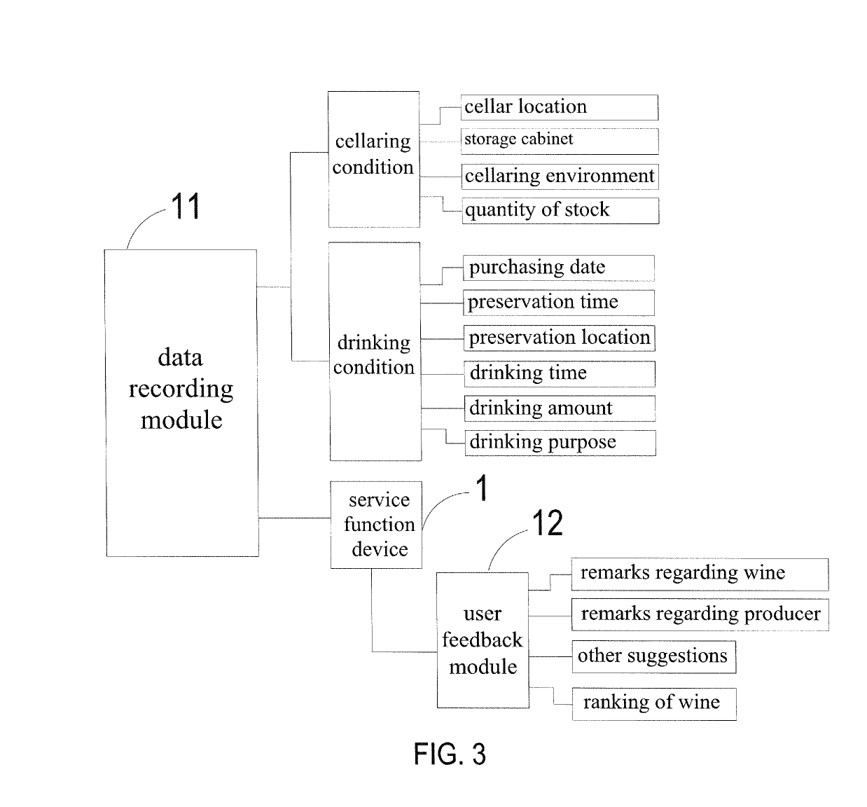

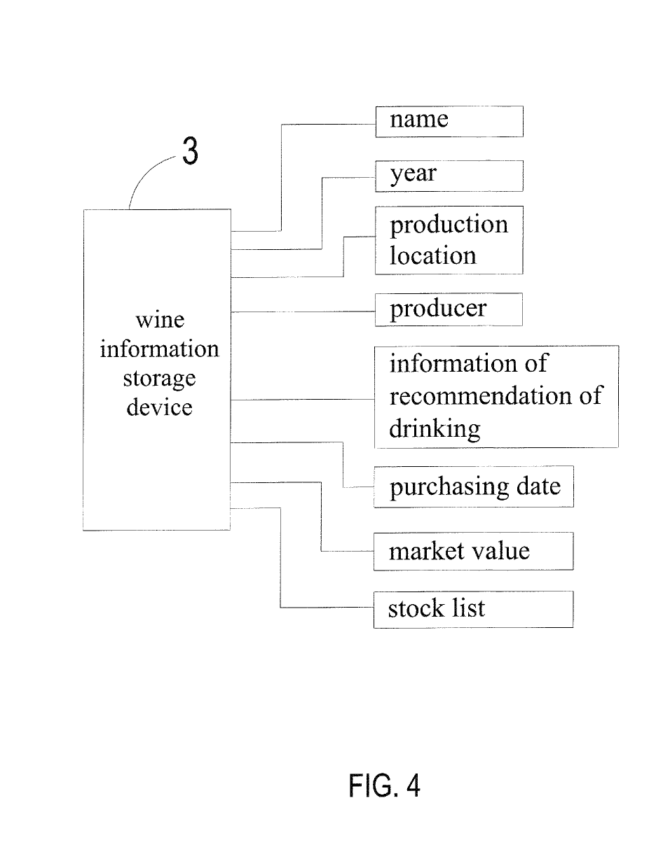

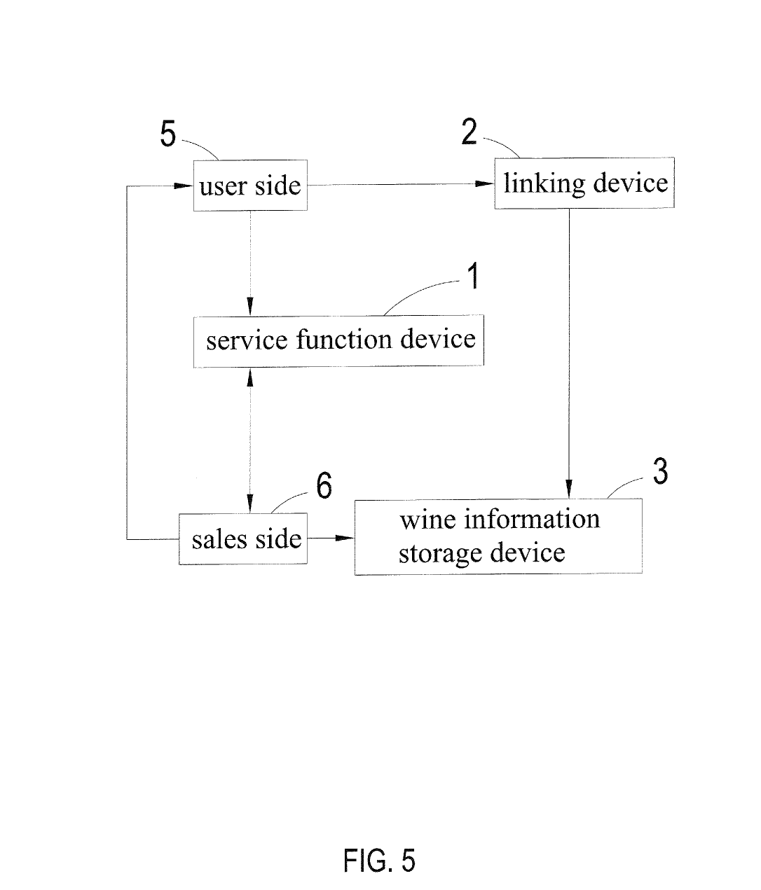

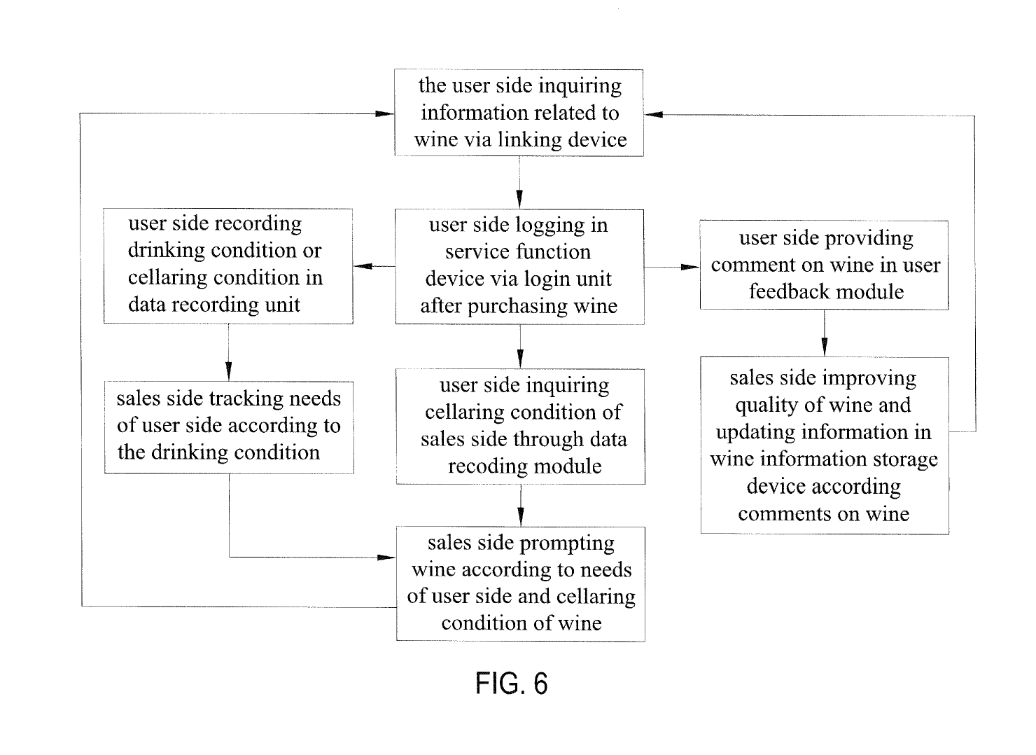

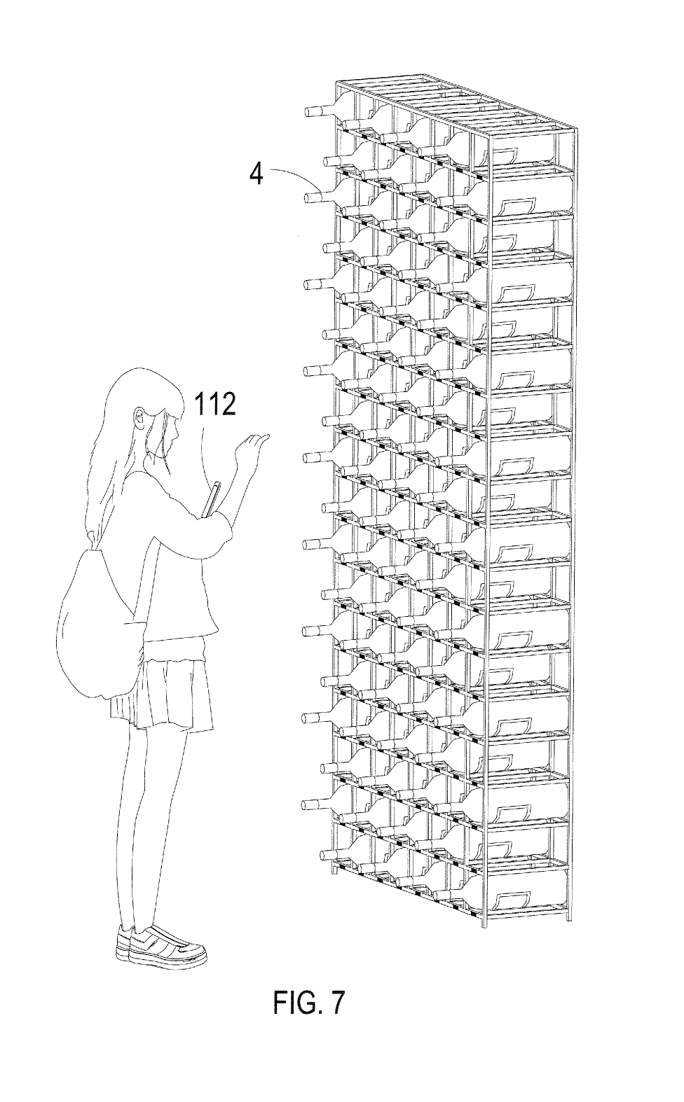

Referring to FIGS. 1-7, which are respectively a perspective view and a block diagram of a preferred embodiment of the present invention, a tree diagram illustrating service items of a bidirectional service device of the preferred embodiment of the present invention, a tree diagram illustrating storage items of a wine information storage device of the preferred embodiment of the present invention, a schematic view illustrating a bidirectional service of the preferred embodiment of the present invention, a schematic view illustrating a flow of process of the preferred embodiment of the present invention, and a schematic view illustrating an example of use of the preferred embodiment of the present invention, these drawings clearly show that with the above components properly combined, before purchasing a bottle of wine 4, a user uses a mobile device to scan, through QR Code, the linking device 2 to connect to the wine information storage device 3 for inquiring, for the wine 4 to be purchased, the source of the wine 4, the producer, production year, information of recommendation of drinking, purchasing date, market value, and/or stock list of the wine 4 in order to know the outside appearance, nature, quality, and value of the wine 4 and even to identify genuineness of the wine to thereby enhance the appetite of purchasing the wine 4.

After purchasing the wine 4, the user enters, through the login unit 111, the service function device 1 to register personal data in order to enable the sales side 6 to provide customized service and to record the purchasing date, the preservation site, and preservation manner of the wine 4 in the data recording module 11, and in each time of opening the bottle for servicing, to record the drinking time and drinking amount in the data recording unit 112, so that the sales side 6 may, based on the data input from the user side 5, to actively provide suggestions or to provide the user side 5 with a complete set of after service through the information of drinking recommendation contained in the wine information storage device 3, in order to prompt the sales of the wine 4.

After drinking the wine 4, the user side 5 may put down messages including remarks and ranking regarding the wine 4, remarks regarding the producer, and the opinions of drinking with the user feedback module 12 of the service function device 1 and the sales side 6 may acquire, through the user feedback module 12, and understand information regarding preference and drinking habit of the user side 5 in order to timely provide suggest of wine tasting to the user or to recommend other wine 4 according to the user's preference and also to improve and upgrade the quality of wine 4 according to such information and to simultaneously update the wine information storage device 3 with such improvement and upgrading. As such, the user side 5 may acquire correct knowledge regarding wine drinking and enjoy the best after service and the sales side 6 can actually get aware of the needs of the user side 5 to effectively increase the success of promotion and sales thereby providing both purchasing and sales sides with the best interest.

Further, the sales side 6 or the user side 5 that has a large quantity of collection of wine 4 is provided with an integration function similar to a warehousing system, where the cellaring condition recorded in the data recording module 11 allows the sales side 6 or the user side 5 to easily know, through the service function device 1, the storage location, the preservation cabinet, the quantity of stock, and the storage environment of the wine 4 so as to help the user side 5 or the sales side 6 to manage the wine owned thereby.

Thus, with reference being had to all the drawings, the present invention, when put into use, provides the following advantages as compared to the known techniques:

(1) The user side 5 may instantaneously inquire most recently updated information of wine 4.

(2) The user side 5 may be provided with knowledge of drinking of wine 4.

(3) The user side 5 may enjoy customized recommendation for drinking of wine 4.

(4) The sales side 6 may efficiently modify the information of wine 4 according to the preference of a user.

(5) The sales side 6 may prompt wine 4 owned thereby according to the needs and recommendations of users.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A bilateral service app for wine tracking and management, the bidirectional service device comprising:
a service function device, which enables a sales side to track and manage information related to a user side;
a linking device, which is mounted to wine, the linking device allowing the user side to inquire information related to the wine;
an wine information storage device, which is in information connection with the linking device, the wine information storage device modifying and updating information of the wine through the service function device;
a data recording module, which is arranged in the service function device to record drinking condition of the wine or cellaring condition of the wine; and
a user feedback module, which is arranged in the service function device to allow the user side to provide comments about the wine.

2. The bilateral service app for wine tracking and management according to claim 1, wherein the linking device is one of one of barcode, QR code, and near field communication (NFC).

3. The bilateral service app for wine tracking and management according to claim 1, wherein the data recording module comprises website access, mobile applications (APP), or electronic documents.

4. The bilateral service app for wine tracking and management according to claim 1, wherein the data recording module comprises at least one login unit for information connection with the user side and a data recording unit for recording the drinking condition of the wine, personal information of the user side, and the cellaring condition of the wine.

5. The bilateral service app for wine tracking and management according to claim 1, wherein the drinking condition includes purchasing date, preservation time, preservation location, drinking time, drinking amount, and drinking purpose of the wine.

6. The bilateral service app for wine tracking and management according to claim 1, wherein the comments about the wine include remarks and ranking of the wine and remarks and other suggestions of the producer provided by the user side.

7. The bilateral service app for wine tracking and management according to claim 1, wherein the wine information storage device comprises storage items including wine name, wine year, wine source, wine producer, information of recommendation of drinking, purchasing date, market value, and stock list.

8. The bilateral service app for wine tracking and management according to claim 1, wherein the user side inquires the information of the wine and records the drinking condition by operation with a computer or a mobile device.

9. The bilateral service app for wine tracking and management according to claim 1, wherein the wine is one of red wine, white wine, and yellow rice or millet wine.

10. The bilateral service app for wine tracking and management according to claim 1, wherein the cellaring condition includes cellar location, storage cabinet, quantity of stock, and cellaring environment of the wine.
